(19) United States
(12) Patent Application Publication
(10) Pub. No.: US 2026/0202351 A1
(43) Pub. Date: Jul. 16, 2026

(54) SYSTEMS AND METHODS FOR TESTING OPTICAL PLATES

(71) Applicant: LUMUS LTD., Ness Ziona (IL)

(72) Inventors: Elad SHARLIN, Mishmar David (IL); Ronen CHRIKI, Lod (IL); Amir SHAPIRA, Ness Ziona (IL); Yochay DANZIGER, Kfar Vradim (IL); Yuval RUBIN, Ness Ziona (IL)

(21) Appl. No.: 19/131,238

(22) PCT Filed: Mar. 21, 2024
(86) PCT No.: PCT/IL2024/050298

§ 371 Date: May 20, 2025

Related U.S. Application Data
(60) Provisional application No. 63/460,329, filed on Apr. 19, 2023.

(51) Int. Cl. G01N 21/958; G01N 21/47

(52) U.S. Cl. CPC G01N 21/958; G01N 21/4738

(57) ABSTRACT

Systems and methods test optical plates for blemishes. An optical plate has first and second end surfaces and a pair of mutually-parallel major external surfaces that support propagation of light through the optical plate by internal reflection at the major external surfaces. A light source generates light and is deployed proximate the optical plate such that the light generated by the light source enters the optical plate proximate the first end surface and propagates through the optical plate toward the second end surface by internal reflection at the major external surfaces. A detector arrangement has at least a first detector that is deployed in association with the first of the major external surfaces and detects light generated by the light source that exits the optical plate through the first of the major external surfaces due to blemish induced scattering of the light propagating through the optical plate by internal reflection.

### CROSS-REFERENCE TO RELATED APPLICATIONS

This application claims priority from U.S. Provisional Patent Application No. 63/460,329, filed Apr. 19, 2023, whose disclosure is incorporated by reference in its entirety herein.

### TECHNICAL FIELD

The present disclosure relates to testing systems and methods, and, in particular, it concerns systems and methods for testing optical plates for blemishes through detection of scattered light.

### BACKGROUND OF THE INVENTION

Optical arrangements for near eye display (NED), head mounted display (HMD) and head up display (HUD) require large aperture to cover the area where the observer's (user's) eye is located (commonly referred to as the eye-motion box—or EMB). In order to implement a compact device, the image that is to be projected into the observer's eye is generated by a small optical image generator (projector) having a small optical aperture. The image from the image projector is conveyed to the eye by an optical waveguide (also referred to as a light-transmitting substrate or light-guide optical element). The image light from the projector is injected into the optical waveguide, which guides the image light by internal reflection at mutually-parallel major external surfaces of the optical waveguide and gradually couples-out the image light (for example via partial reflectors embedded in the optical waveguide or diffractive elements) thereby expanding (multiplying) the image in at least one dimension to generate a large aperture. Even the smallest blemish in the optical waveguide, in particular at or near one or more of the parallel major external surfaces of the optical waveguide, may disrupt conditions for internal reflection, and therefore minimum blemishes in the optical waveguide is paramount in order to produce a clear and crisp image for the observer. Conventional measurement tools and apparatuses lack the sensitivity needed to identify even minor optical waveguide blemishes.

### SUMMARY OF THE INVENTION

The present disclosure provides systems and methods for testing optical plates for blemishes through detection of scattered light.

According to the teachings of an embodiment of the present disclosure, there is provided a system for testing an optical plate for blemishes. The optical plate includes a plurality of surfaces including first and second end surfaces and a pair of mutually-parallel major external surfaces for supporting propagation of light through the optical plate by internal reflection at the major external surfaces. The system comprises: a light source that generates light and is deployed proximate to the optical plate such that the light generated by the light source enters the optical plate proximate the first end surface and propagates through the optical plate toward the second end surface by internal reflection at the major external surfaces; and a detector arrangement including at least a first detector that is deployed in association with the first of the major external surfaces and configured to detect light generated by the light source that exits the optical plate through the first of the major external surfaces due to blemish induced scattering of the light propagating through the optical plate by internal reflection.

Optionally, the detector arrangement further includes a second detector deployed in association with a second of the major external surfaces.

Optionally, the system further comprises: an absorber arrangement including at least one light-absorbing surface, the absorber frame arrangement for deployment relative to the optical plate so that the at least one light-absorbing surface is associated with a corresponding one of the surfaces of the optical plate.

Optionally, the plurality of surfaces further includes a first edge surface and a second edge surface, and the at least one light-absorbing surface includes a plurality of light-absorbing surfaces including: a first light-absorbing surface associated with the first of the major external surfaces, a second light-absorbing surface associated with a second of the major external surfaces, a third light-absorbing surface associated with the second end surface, a fourth light-absorbing surface associated with the first edge surface, and a fifth light-absorbing surface associated with the second edge surface.

Optionally, the optical plate includes one or more optical coating layers at one or more of the major external surfaces.

Optionally, the optical plate includes at least one optical component deployed internal to the optical plate between the major external surfaces.

Optionally, the at least one optical component includes a plurality of partially reflecting surface obliquely inclined to the major external surfaces.

Optionally, the at least one optical component includes a partially reflecting surface parallel to the major external surfaces.

Optionally, the optical plate is formed as a stack of a plurality of constituent optical plates.

Optionally, the optical plate is part of a bonded stack of optical plates.

Optionally, the system further comprises: an integrating sphere including an input region associated with the light source and at least a first output region associated with the first detector.

Optionally, the first output region is associated with the second end surface of the optical plate.

Optionally, the first output region is associated with one of the major external surfaces of the optical plate.

Optionally, the system further comprises: at least one computer processor electrically associated with the detector arrangement and configured to process signals, generated by the detector arrangement in response to the first detector detecting the light generated by the light source that exits the optical plate, to derive an integrity measure of the optical plate.

Optionally, the integrity measure is a count of a number of detections of the light generated by the light source that exits the optical plate by the first detector, and the at least one processor is further configured to perform a comparison of the count of the number of detections to one or more thresholds and output a usability status of the optical plate based on the comparison.

There is also provided according to the teachings of an embodiment of the present disclosure a system for testing an optical plate for blemishes. The optical plate includes a plurality of surfaces including first and second end surfaces and a pair of mutually-parallel major external surfaces for supporting propagation of light through the optical plate by internal reflection at the major external surfaces. The system comprises: an integrating sphere including an input region and at least a first output region; a light source that generates light and is positioned external to the integrating sphere and proximate the input region; and a detector arrangement including a photodetector that is positioned external to the integrating sphere and proximate the first output region, and the integrating sphere, the light source, and the detector arrangement are arranged such that the light generated by the light source passes through the input region to enter the optical plate proximate the first end surface and propagates through the optical plate toward the second end surface by internal reflection at the major external surfaces and light reflected from an internal surface of the integrating sphere passes through the output region to the photodetector, and the light reflected from the internal surface is a proportion of the light propagating through the optical plate by internal reflection at the major external surfaces that exits the optical plate through one of the major external surfaces due to blemish induced scattering.

Optionally, the first output region is associated with the second end surface of the optical plate.

Optionally, the first output region is associated with one of the major external surfaces of the optical plate.

Optionally, the system further comprises: an imaging system having at least one image sensor associated with a second output region of the integrating sphere for capturing one or more images of interior portions of the integrating sphere.

Optionally, the integrating sphere is formed from a pair of hemi-spherical sections that are spatially separated from each other to form an air gap therebetween for receiving the optical plate.

Optionally, the air gap defines the input region and the output region.

There is also provided according to the teachings of an embodiment of the present disclosure a system for testing an optical plate for blemishes. The optical plate includes a plurality of surfaces including first and second end surfaces and a pair of mutually-parallel major external surfaces for supporting propagation of light through the optical plate by internal reflection at the major external surfaces. The system comprises: a light source deployed in association with a first of the major external surfaces, the light source configured to generate light that impinges on the first of the major external surfaces such that the generated light encounters a blemish of the optical plate and a proportion of the generated light undergoes blemish induced scattering so as to be coupled into optical plate a propagate by internal reflection at the major external surfaces toward the first end surface or the second end surface; and a detector that is deployed in association with the first end surface or the second end surface such that the detector detects the light propagating through the optical plate by internal reflection at the major external surfaces.

There is also provided according to the teachings of an embodiment of the present disclosure a method for testing an optical plate for blemishes. The optical plate includes a plurality of surfaces including first and second end surfaces and a pair of mutually-parallel major external surfaces for supporting propagation of light through the optical plate by internal reflection at the major external surfaces. The method comprises: deploying the optical plate relative to a detector arrangement having at least a first detector and a light source such that the first detector is associated with a first of the major external surfaces and light generated by the light source enters the optical plate proximate the first end surface and propagates through the optical plate toward the second end surface by internal reflection at the major external surfaces; and detecting light generated by the light source that exits the optical plate through one of the major external surfaces due to blemish induced scattering.

Optionally, the detector arrangement further includes a second detector, and the deploying the optical plate is such that the second detector is associated with a second of the major external surfaces.

Optionally, the optical plate includes one or more optical coating layers at one or more of the major external surfaces.

Optionally, the optical plate includes at least one optical component deployed internal to the optical plate between the major external surfaces.

Optionally, the at least one optical component includes a plurality of partially reflecting surface obliquely inclined to the major external surfaces.

Optionally, the at least one optical component includes a partially reflecting surface parallel to the major external surfaces.

Optionally, the optical plate is formed as a stack of a plurality of constituent optical plates.

Optionally, the optical plate is part of a bonded stack of optical plates.

Optionally, the method further comprises: deploying an absorber arrangement including at least one light-absorbing surface such that the at least one light-absorbing surface is associated with a corresponding one of the surfaces of the optical plate.

Optionally, the plurality of surfaces further includes a first edge surface and a second edge surface, and the at least one light-absorbing surface includes a plurality of light-absorbing surfaces including: a first light-absorbing surface associated with the first of the major external surfaces, a second light-absorbing surface associated with a second of the major external surfaces, a third light-absorbing surface associated with the second end surface, a fourth light-absorbing surface associated with the first edge surface, and a fifth light-absorbing surface associated with the second edge surface.

Optionally, the deploying includes positioning the optical plate in an integrating sphere having an input region and an output region such that the input region is associated with the light source and the output region is associated with the first detector.

Optionally, the method further comprises: capturing, by at least one image sensor, one or more images of interior portions of the integrating sphere.

Optionally, the integrating sphere is formed from a pair of hemi-spherical sections that are spatially separated from each other to form an air gap therebetween, and the deploying includes positioning the optical plate in the air gap.

Optionally, the scattering is caused by at least one blemish at one or both of the major external surfaces.

Optionally, the method further comprises: cleaning or polishing the optical plate to at least partially remove the at least one blemish.

Optionally, the scattering is caused by at least one blemish that includes one or more of: a surface level blemish or a bulk blemish.

Optionally, the surface level blemish is selected from the group consisting of: a dent, a scratch, a chip, dust, dirt, debris, one or more particulates, an inhomogeneity, residue from an adhesive, a rough region of one or both of the major external surfaces, and a discontinuity in an optical coating at one or both of the major external surfaces.

Optionally, the bulk blemish is selected from the group consisting of: an inhomogeneity at one or more internal portions of the optical plate and bubbles in one or more internal portions of the optical plate.

Unless otherwise defined herein, all technical and/or scientific terms used herein have the same meaning as commonly understood by one of ordinary skill in the art to which the disclosure pertains. Although methods and materials similar or equivalent to those described herein may be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present disclosure are herein described, by way of example only, with reference to the accompanying drawings. With specific reference to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

Attention is now directed to the drawings, where like reference numerals or characters indicate corresponding or like components. In the drawings:

FIG. 1A is a schematic side view of a system for testing optical plates according to an embodiment of the present disclosure, showing a light source for emitting light into a clean optical plate under test and a detector associated with a first major external surface of the clean optical plate for sensing light emitted by the light source, and showing propagation of light by internal reflection through the clean optical plate;

FIG. 1B is a schematic top view corresponding to FIG. 1A;

FIG. 2 is a schematic side view similar to FIG. 1A, but in which the optical plate under test has blemishes, and showing part of the light propagating through the optical plate by internal reflection deflecting out of the optical plate from the first major external surface of the optical plate toward the detector;

FIG. 3 is a schematic side view of a section of the optical plate of FIG. 2, showing the interaction of the propagating light with a blemish that scatters the light such that part of the scattered light is deflected out of the optical plate toward the detector;

FIG. 4 is a schematic side view similar to FIG. 2, but showing an additional detector deployed to sense part of the propagating light that deflects out of the optical plate from a second major external surface of the optical plate;

FIGS. 5A and 5B are schematic side and top views, respectively, of a system for testing optical plates having a light-absorbing frame surrounding the optical plate under test, according to an embodiment of the present disclosure;

FIG. 6 is a schematic side view of a system for testing optical plates similar to FIG. 5A, but further showing an integrating sphere that receives the optical plate under test, according to an embodiment of the present disclosure;

FIG. 7 is a schematic side view of a system for testing optical plates similar to FIG. 6, but further showing a pair of imaging sensors that form an imaging system for capturing images of interior portions of the integrating sphere, according to an embodiment of the present disclosure;

FIG. 8 is a schematic side view of a system for testing optical plates similar to FIG. 6, but in which the integrating sphere is formed from a pair of hemi-spherical sections that are spatially separated from each other to form an air gap in which the optical plate under test can be received, according to an embodiment of the present disclosure;

FIG. 9 is a schematic side view of a system for testing optical plates, in which the optical plate under test has blemishes, showing a light source associated with a first major external surface of the optical plate for emitting light into the optical plate and a detector for sensing light emitted by the light source, and showing part of the light emitted by the light source deflected into the optical plate so as to propagate through the optical plate by internal reflection;

FIG. 10 is a schematic side view of a section of the optical plate of FIG. 9, showing the interaction of light emitted by the light source with an imperfection that scatters the light such that part of the scattered light is deflected at an angle so as to propagate through the optical plate by internal reflection;

FIG. 11 is a schematic side view similar to FIG. 1A, but in which the optical plate under test is in the form of a light-guide optical element having a pair of mutually-parallel major external surfaces and a series of mutually-parallel partially reflective internal surfaces obliquely inclined relative to the major external surface;

FIG. 12 is a schematic side view of a system for testing optical plates that is similar to FIG. 1A, but in which the optical plate under test is formed as a stack of clean constituent optical plates, and further showing an integrating sphere that receives the optical plate under test; and

FIG. 13 is a schematic side view similar to FIG. 12, but in which at least one of the constituent optical plates of the stack under test has at least one blemish, such that part of the light propagating through the stack by internal reflection is deflected out of the stack and reflected from the internal surface of the integrating sphere.

### DESCRIPTION OF THE PREFERRED EMBODIMENTS

Certain embodiments of the present disclosure provide systems and methods for testing optical plates for blemishes through detection of scattered light.

The principles and operation of the systems and methods according to the present disclosure may be better understood with reference to the drawings accompanying the description.

Before explaining at least one embodiment of the disclosure in detail, it is to be understood that the disclosure is not necessarily limited in its application to the details of construction and the arrangement of the components and/or methods set forth in the following description and/or illustrated in the drawings and/or the examples. The disclosure is capable of other embodiments or of being practiced or carried out in various ways. Initially, throughout this document, references are made to directions such as, for example, upper and lower, left and right, and the like. These directional references are exemplary only to illustrate the embodiments of the disclosure. Furthermore, it should be noted that the optical plates as illustrated in the drawings are not necessarily shown to scale.

The systems and methods of the present disclosure can be used to test optical materials of various types and sizes, and is of particular value when used to test smaller-scale optical plates that are used in the fabrication of optical substrate devices, or are themselves optical substrate devices, that are used in a near eye display (NED), head mounted display (HMD), and head up display (HUD).

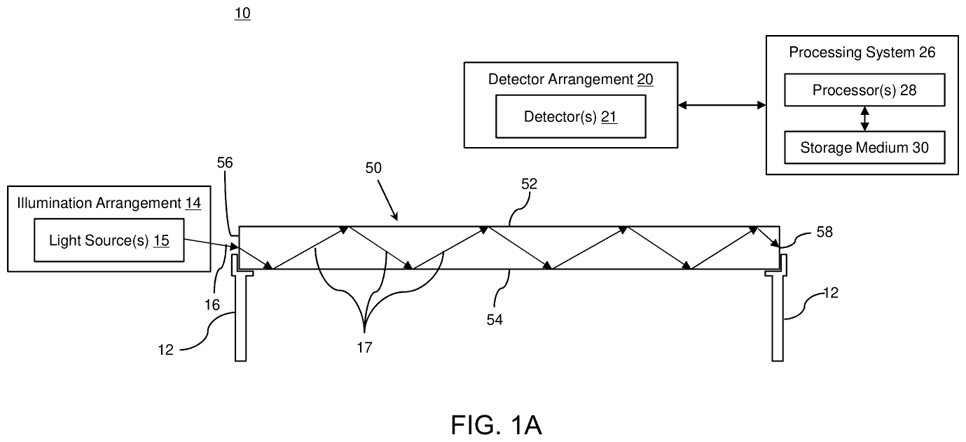

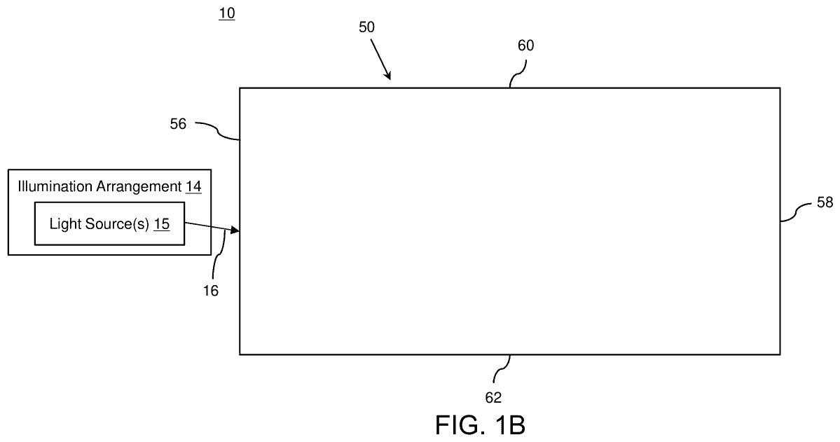

Referring now to the drawings, FIGS. 1A and 1B schematically illustrate a system, generally designated 10, for testing an optical plate 50 for blemishes, according to the teachings of an embodiment of the present disclosure. Generally speaking, the system 10 includes an illumination arrangement 14 having at least one light source 15 for generating (emitting) light, and a detection arrangement 20 having at least one detector (i.e., “optical sensor” or “photodetector”) 21 for detecting/sensing light generated (emitted) by the light source 15, in particular light emitted by the light source 15 that enters into the optical plate 50 and subsequently exits out of the optical plate 50. The system 10 may also include a processing subsystem 26, having at least one computerized processor 28 coupled to a computerized storage medium 30 (such as a computer memory or the like), electrically associated with the detection arrangement 20 for receiving signals from the detection arrangement 20 and deriving from the received signals an integrity measure of the optical plate 50.

The optical plate 50 is formed from a light-transmitting material (e.g., glass). Generally speaking, the optical plate 50 includes a plurality of external surfaces, including a pair of mutually-parallel major external surfaces 52, 54 that support propagation of light through the optical plate 50 by internal reflection at the major external surfaces 52, 54. In the non-limiting examples illustrated in the drawings, the external surfaces further include a pair of opposing end surfaces 56, 58 and a pair of edge surfaces 60, 62.

Parenthetically, the propagation of light through the optical plate 50 by internal reflection may be total internal reflection (TIR) whereby propagating light that is incident to the major external surfaces 52, 54 at angles greater than a critical angle (defined in part by the refractive index of the light-transmitting material and the refractive index of the medium surrounding the optical plate 50, e.g., air, optical coating(s), etc.) is totally internally reflected at the major external surfaces 52, 54. Alternatively, the propagation by internal reflection may be effectuated by an optical coating, such as an angularly selective reflective coating, applied to the major external surfaces 52, 54 to achieve reflection of light that is incident to the major external surfaces 52, 54 within a particular angular range. Within the context of this document, light that propagates by internal reflection through a light-transmitting material (such as an optical plate) is referred to as being “guided” or “trapped” by internal reflection.

Returning to FIGS. 1A and 1B, the illumination arrangement 14 and the detector arrangement 20 are each deployed proximate to the optical plate 50 in a particular arrangement and orientation. Specifically, the optical plate 50 and the detector arrangement 20 are deployed relative each other such that the detector 21 is associated with one of the major external surfaces 52 (in this example the upper surface 52, but the detector 21 can be deployed in association with the lower surface 54) so as to be able to detect light that exits (escapes) the optical plate 50 from one of major external surfaces 52. Collection optics (not shown), may be deployed between the detector 21 and the major external surface of the optical plate 50 in order to direct the escaping light onto the detector 21. The optical plate 50 and the illumination arrangement 14 are deployed relative each other such that light (represented schematically in FIG. 1A as a beam of illumination having sample ray 16) that is generated by the light source 15 enters the optical plate 50 proximate one of the end surfaces 56 (for example through the end surface 56) and propagates through the optical plate 50 along a propagation direction toward the other end surface 58 by internal reflection at the major external surfaces 52, 54. This deployment may be achieved by positioning the light source 15 proximate to the end surface 56. The light that propagates by internal reflection through the optical plate 50 is designated as 17 in the drawings. In the illustrated example, the propagation direction coincides with a direction of elongation of the optical plate 50 (which is along the horizontal dimension in the figure). Once the light 17 reaches the end surface 58, the light may, in some cases, freely exit the optical plate 50 through the surface 58, or, in other cases, may be absorbed by a light-absorbing coating layer deployed at the end surface 58.

The deployment of the illumination arrangement 14 and the detector arrangement 20 relative to the optical plate 50 may be facilitated by a mounting arrangement 12 that receives and positions the optical plate 50. The mounting arrangement 12 may be configured to receive the optical plate 50 and position the received optical plate 50 relative to the light source 15 and the detector arrangement 20 in the particular arrangement and orientation. Preferably, the light source 15 and the detector 21 are positioned at particular locations and orientations relative to the mounting arrangement 12, thus providing the particular arrangement and orientation of the optical plate 50 relative to the light source 15 and the detector arrangement 20 when the optical plate 50 is received in the mounting arrangement 12. In certain embodiments, the illumination arrangement 14 and the detector arrangement 20 are mechanically coupled to the mounting arrangement 12 at the particular locations and orientations relative to the mounting arrangement 12. In other embodiments, the mounting arrangement 12 is mechanically separated from the illumination arrangement 14 and the detector arrangement 20. The mounting arrangement 12, although illustrated purely schematically in the drawings, can be implemented as any suitable mechanical arrangement commonly used to hold optical substrates, such as benchtop optical mounts or substrate holders used in spectroscopy.

Regarding the illumination arrangement 14, it is noted that the wavelength(s) of light emitted by the illumination arrangement 14 can be in any suitable region of the electromagnetic spectrum, e.g., visible spectrum, infrared, UV, etc. In embodiments in which more than one light source 15 is used, the light sources 15 may emit light of the same wavelength or of different wavelengths. It is additionally noted that the light source 15 can produce a broad beam that fills the input aperture of the optical plate 50, and in that respect the ray of the beam of illumination 16 emitted by the light source 15 illustrated in FIG. 1A is merely representative of one of many rays that span the beam. Consequently, the propagating light 17 shown in the drawings is merely a sample of the beam of propagating illumination that corresponds to one of the sample rays of the input illumination 16, and the propagating light 17 in actuality preferably fills the optical plate 50 so that all (or practically all) of the parts of the major external surfaces are impinged upon by the illumination 17. Alternatively, the light source 15 can produce a narrower beam of light, and a mechanism for panning and tilting the light source 15 can be provided to accommodate a mechanical spanning of the input aperture.

When the optical plate 50 is ideal, the optical plate 50 does not include any blemishes, or includes only minor or subtle blemishes, and conditions of internal reflection are maintained along the entire propagation direction of the optical plate 50, such that the propagating light 17 is guided through the optical plate 50 without leakage through the major external surfaces 52, 54 or without significant loss in intensity. In such ideal conditions, the optical plate is referred to as being a “clean plate”. In FIG. 1A, the optical plate 50 is a clean plate. As a result, the light 17 is guided by internal reflection through the optical plate 50 without leakage, and the detector 21 does not detect any light exiting through the major external surface 52 with which the detector 21 is associated (or detects a negligible amount of light).

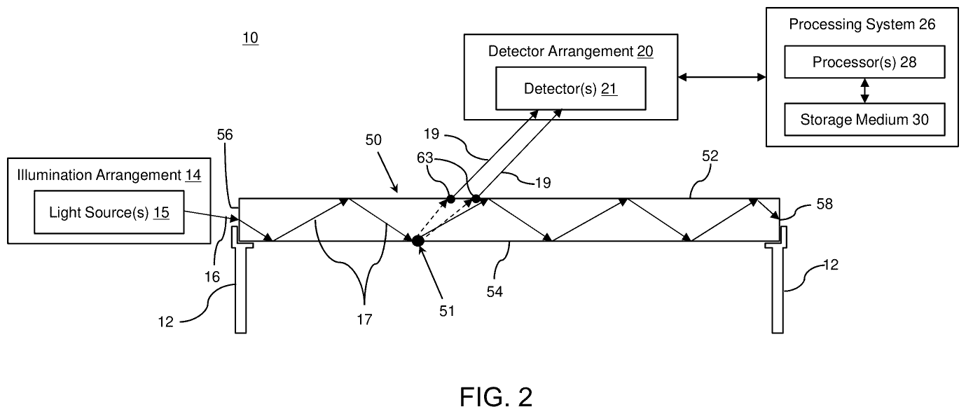

Turning now to FIG. 2, here the optical plate 50 is no longer a “clean plate”, and includes one or more blemishes (also referred to interchangeably herein as “surface and/or bulk imperfections in the optical plate”, “surface or and/or bulk inconsistencies in the optical plate”, or “surface and/or bulk abnormalities in the optical plate”) which disrupt conditions of internal reflection, which can present as “haze” in the optical plate 50. In particular, these blemishes, which can be surface and/or bulk blemishes, are such that when the propagating beam 17 encounters a blemish (represented as dot 51 in the figure), part of the propagating beam 17 becomes scattered (i.e., part of the beam undergoes blemish induced scattering), resulting in propagation of light at angles which do not satisfy conditions for internal reflection, and which ultimately result in part of the propagating beam 17 exiting (escaping) the optical plate 50 through one or more of the major external surfaces 52, 54. In FIG. 2, the light that propagates at angles that do not satisfy conditions for internal reflection are represented as dashed rays, and the light that exits the optical plate 50 (due to scattering) through the major external surface 52 is represented by rays 19 (which are continuations of the dashed rays). In the illustrated example, the rays 19 exit the optical plate 50 at points 63 of the major external surface 52. In this case, the detector 21, which is deployed in association with the major external surface 52 through which the light escapes, detects/senses the escaping light 19.

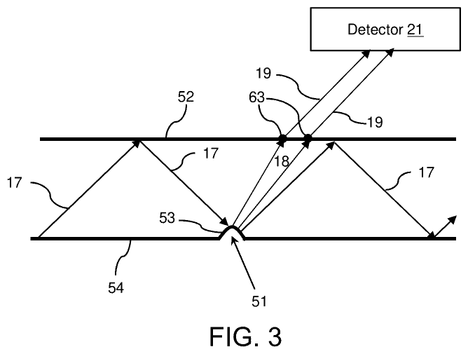

FIG. 3 is a close-up of a section of the optical plate 50 of FIG. 2, illustrating an example of the blemish 51 in the optical plate 50 that may cause the propagating beam 17 to scatter. Here, the blemish 51 is an indentation in the major external surface 54, generally formed as a dent, depression, pit, cavity, or crevice in the major external surface. This indentation causes a small portion of the major external surface 54 to protrude inward into the interior section of the optical plate 50. The protruding portion (i.e., the protrusion) is generally designated 53 in FIG. 3. As a result of the indentation, part of the light 17 that encounters the protrusion 53 is reflected in multiple directions (i.e., scattered) by the protrusion 53, schematically represented by scattered light rays 18. The light rays 18 are scattered in various directions due to the variation in the surface profile of the protrusion 53 such that at least some of the scattered light 18 propagates at angles which do not satisfy conditions for internal reflection and escapes the optical plate 50, for example through points 63 as light rays 19. Some of the scattered light may be at an angle that satisfies conditions of internal reflection, and therefore a proportion of the intensity of some of the scattered light may continue to propagate by internal reflection at the major external surfaces 52, 54.

It is noted that the indentation illustrated in FIG. 3 is merely one illustrative example of a type of blemish that may be present in an optical plate under test, and one illustrative example of a location of a blemish in an optical plate under test. In general, blemishes of an optical plate under test that can be detected by the embodiments of the present disclosure can be located at various regions of the optical plate, including external portions of the optical plate (i.e., at portions of one or both of the major external surfaces 52, 54) and/or internal portions of the optical plate (i.e., bulk portions), although in certain cases blemishes are more often located in proximity to the major external surfaces (i.e., external to the optical plate and/or internal to the optical plate but close to the major external surfaces). Furthermore, the embodiments of the present disclosure can detect the presence of (i.e., identify) various types of surface blemishes and bulk blemishes including, but not limited to, dents, scratches, chips, dust, dirt, debris, particulates, inhomogeneities, or residue from adhesive located at one or both of the major external surfaces 52, 54, discontinuities or unevenness of optical coatings (including cracking, flaking, peeling, blistering, and cloudiness in the optical coating) applied at one or both of the major external surfaces 52, 54, rough region(s) of one or both of the major external surfaces 52, 54, inhomogeneities at one or more internal portions or regions of the optical plate (i.e., bulk inhomogeneities), gas (e.g., air) bubbles in one or more internal portions or regions of the optical plate, and the like. The blemishes in optical plates under test may occur from various causes. For example, rough regions of the major external surfaces may arise due to incomplete or partial polishing of the optical plate. Polishing may, for example, also create dents. Scratches or chips at one or both of the major external surfaces may occur, for example, from mishandling (e.g., dropping) of the optical plate. Adhesive residue may build up on one or both of the major external surfaces of the optical plate, for example in cases where the optical plate is formed from multiple material layers glued (adhesively bonded) one to the other. Dust, dirt, debris, and particulates may, for example, naturally build up on one or both of the major external surfaces over time or during fabrication processes, and potentially can be removed by cleaning or polishing. Bulk blemishes, such as bubbles and internal inhomogeneities may, for example, occur during the fabrication process of the raw materials used to produce the optical plate, for example during formation of the glass from which the optical plate is extracted. It is also noted that the scattering pattern illustrated in FIG. 3 is merely a representation of a possible scattering pattern caused by a blemish of the optical plate. In principle, some of the light in FIG. 3 could be scattered downward so as to exit the optical plate through the lower major external surface 54, where it could be sensed by a detector deployed in association with the lower major external surface 54. Thus, although FIGS. 2 and 3 illustrate the escaping light 19 exiting the optical plate 50 through the upper major external surface 52 at particular points 63, the light that escapes the optical plate 50 due to lack of conditions of internal reflection caused by blemish induced scattering may exit the optical plate 50 at various points along either of the major external surfaces, where it may be sensed by the detector 21 (or detectors).

In response to detecting/sensing the light 19 that escapes from the optical plate 50, the detector 21 generates detector signals. In certain embodiments, the detector arrangement 20 provides these signals to the processing subsystem 26, and the processor(s) 28 may derive an integrity measure of the optical plate 50 from the received detector signals. In certain embodiments, the integrity measure can be used by the processing subsystem 26 to detect/identify the presence of one or more blemishes in the optical plate. In one example embodiment, the integrity measure is in the form of a signal count, whereby the processing subsystem 26 counts the number of detections (made by the detector 21) of the light 19 (generated by the light source 15) that exits the optical plate 50. In certain embodiments, if the counted number of detections is above a threshold value, the processing subsystem 26 may indicate a positive detection/identification of one or more blemishes. In certain embodiments, the processing subsystem 26 may compare the counted number of detections to one or more threshold values and output a usability status or categorization (or integrity characterization) of the optical plate 50 based on the comparison. For example, if the signal count is within a first range, for example in the range of 0 to 50, the processing subsystem 26 may characterize the optical plate 50 as a “clean plate”. If, for example, the signal count is within a second range, for example in the range of 50 to 200, the processing subsystem 26 may characterize the optical plate 50 as a “dirty plate”. Depending on the location(s) and/or type(s) of blemishes, the “dirty plate” may be cleaned or polished to remove the blemish(s), and then optionally re-tested. The location of blemishes can be identified using an imaging system, as will be discussed in subsequent sections of the present disclosure. As another example, if the signal count is within a third range, for example above 200, the processing subsystem 26 may characterize the optical plate 50 as an “unusable plate” (i.e., a plate that cannot be cleaned or polished enough to reduce the signal count to the first range), and the optical plate may be discarded or recycled. As should be apparent, any suitable number of threshold comparisons and corresponding categories can be applied.

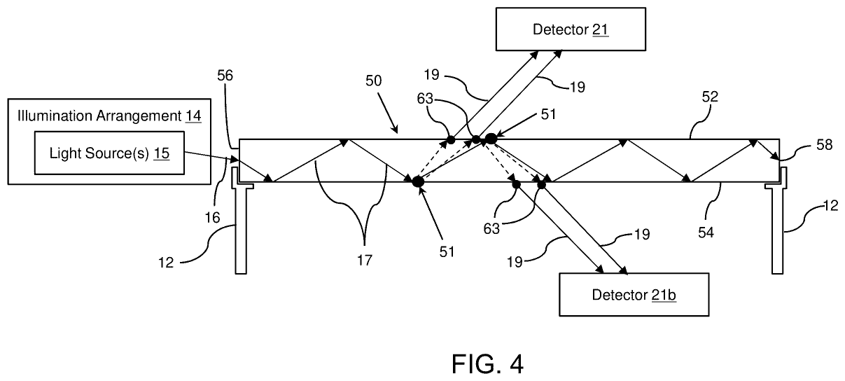

Referring now to FIG. 4, there is illustrated an embodiment of the system 10 similar to as illustrated in FIGS. 1A-2, but in which the detector arrangement 20 includes a second detector 21b deployed in association with the lower major external surface 54 of the optical plate 50. This configuration allows the detector arrangement 20 to detect light emanating from both of the major external surfaces of the optical plate 50, effectively doubling the test region that can be examined by the detector arrangement 20 and thus increasing the overall signal-to-noise ratio (SNR) of the detector signals. In the illustrated example, two blemishes 51 scatter the light 17 that propagates by internal reflection, resulting in propagation of light at angles which do not satisfy conditions for internal reflection (represented in the figure as dashed rays), which result in both of the major external surfaces 52, 54 transmitting escaped light 19.

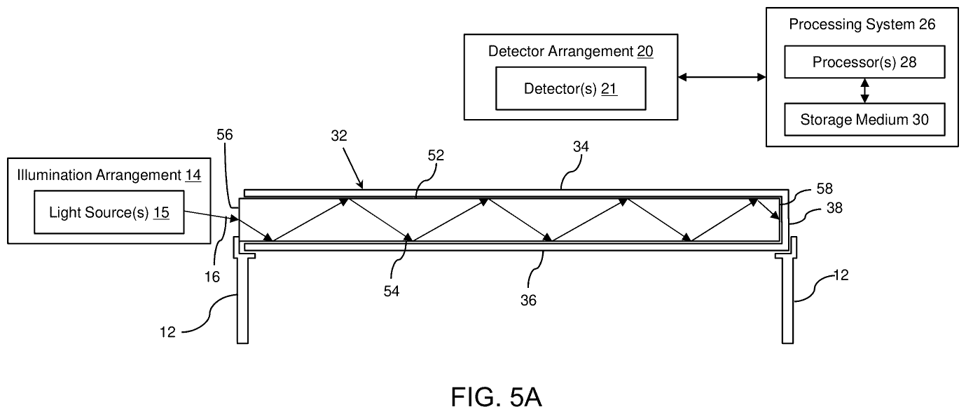

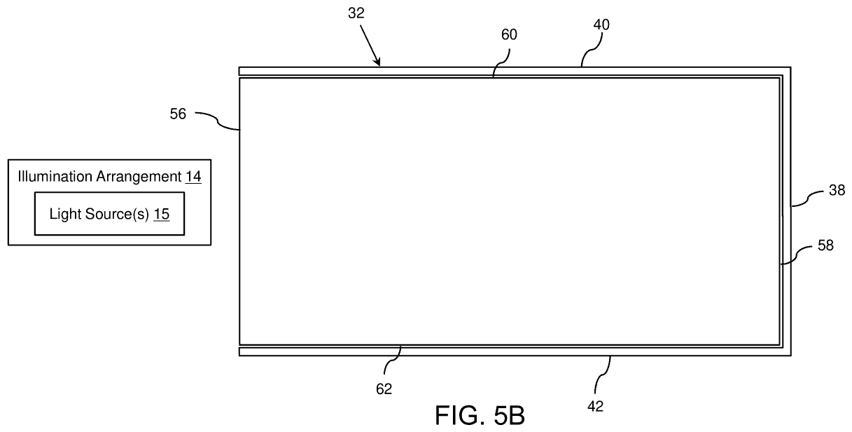

The signal strength of the detector signals can be further improved by employing a light-absorbing arrangement or frame at some or all of the external surfaces of the optical plate 50 in order to reduce the effect of stray light not resulting from scattering. FIGS. 5A and 5B schematically illustrate a non-limiting example of such an embodiment, in which an absorber arrangement 32, in the form of an absorber frame, includes a plurality of light-absorbing surfaces 34, 36, 38, 40, 42 respectively associated with the external surfaces 52, 54, 58, 60, 62. In one non-limiting implementation, the light-absorbing surfaces 34, 36, 38, 40, 42 are implemented as a coating of black paint applied to base surfaces placed in association with the aforementioned surfaces of the optical plate 50. In embodiments in which the propagation of light through the optical plate is by total internal reflection, a small air gap is preferably present between the light-absorbing surfaces 34, 36 and the respective major external surfaces 52, 54, so that conditions of total internal reflection are maintained.

Although the embodiment illustrated in FIGS. 5A and 5B shows each of the external surfaces 52, 54, 58, 60, 62 having a light-absorbing surface associated therewith, reasonable performance may still be achieved with only some of the external surfaces having an associated light-absorbing associated therewith. For example, in certain embodiments only the edge surfaces 60, 62 may have light-absorbing surfaces 40, 42 associated therewith. It is also noted that the embodiments using an absorber arrangement can be used in combination with embodiments in which a single detector is deployed (e.g., the embodiment illustrated in FIGS. 1A-2).

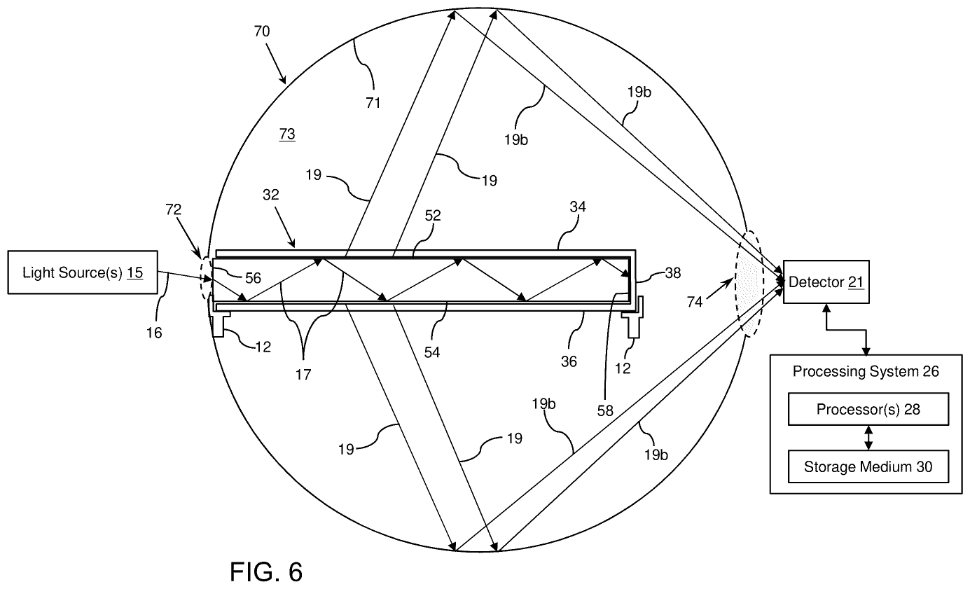

The SNR of the detector signals may be further improved by employing an integrating sphere, which may be particularly advantageous in situations in which the optical plate includes significant surface or bulk scattering centers. FIG. 6 schematically illustrates one such embodiment, in which the optical plate 50 is received within an integrating sphere 70, which as is well-known in the art is a hollow spherical cavity 73 with its interior surface 71 coated with diffuse white reflective coating. The integrating sphere 70 includes an input region 72 and at least one output region 74. The input and out regions can be defined as openings or ports in the sphere 70, or alternatively can be light-transmitting regions, such as light-transmissive windows. In the illustrated embodiment, the light source 15 is deployed externally to the integrating sphere 70 and proximate to the input region 72 of the integrating sphere 70 such that the light 16 emitted by the light source 15 passes through the input region 72 and enters the optical plate (proximate, e.g., through, the end surface 56) and propagates through the optical plate 50 toward the other end surface 58 by internal reflection at the major external surfaces 52, 54. Similar to as in previously described embodiments, when the propagating beam 17 encounters blemishes, part of the propagating beam 17 undergoes scattering so that a proportion of the propagating beam 17 exits the optical plate 50 through the major external surfaces 52, 54. The light 19 that exits the optical plate 50 through the major external surfaces 52, 54 due to blemish induced scattering impinges on the internal surface 71 of the integrating sphere 70. The impinging light 19 is reflected from the internal surface 71 as light 19b. This reflected light 19b passes through the output region 74 of the integrating sphere 70 and reaches the detector 21, which is deployed external to the integrating sphere 70 and proximate the output region 74.

Although the output region 74, and hence the detector 21, are illustrated as being located adjacent to the end surface 58 of the optical plate 50, the location of the output region and the detector may be arbitrary, due largely to the fact that the exiting light 19 typically is subject to uniform scattering or a diffusing effect of the integrating sphere, resulting in the light 19 undergoing multiple reflections from the internal surface 71 of the integrating sphere 70 and thus deflections of the exiting light 19 and multiple angles.

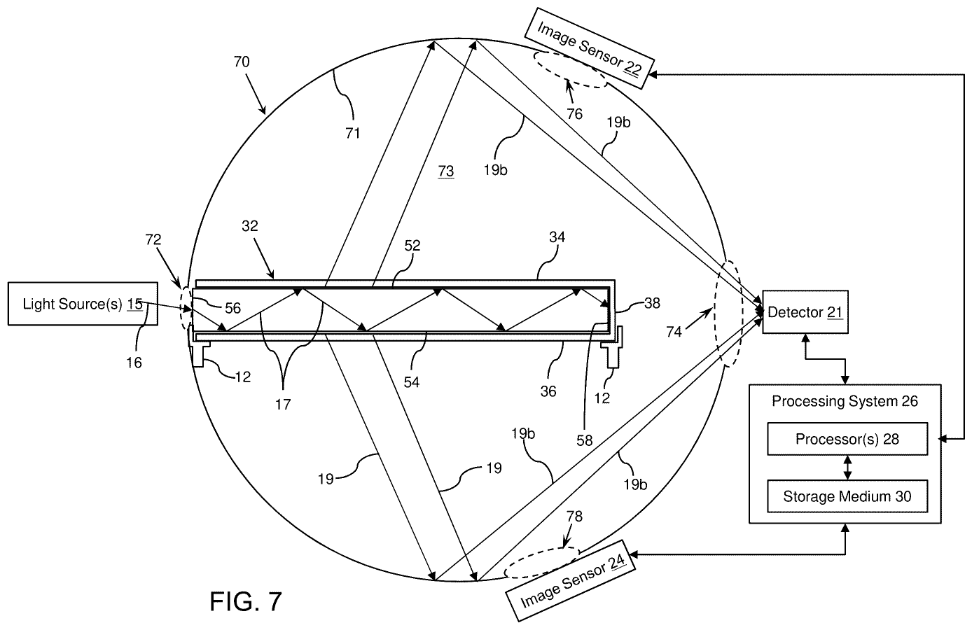

Refer now to FIG. 7, which is similar to the embodiment of FIG. 6, but which includes an imaging system (which can be functionally part of the detector arrangement or separate therefrom) having at least one image sensor, shown in the present example as a pair of image sensors 22, 24. The image sensors 22, 24, which may be implemented as cameras, are each deployed external to the integrating sphere 70 and proximate to respective output regions 76, 78. The image sensors 22, 24 are angulated with respect to the respective output regions 76, 78 so that portions of the interior cavity 73 are within the respective fields of view of the image sensors 22, 24, thereby enabling the image sensors 22, 24 to view the interior cavity 73 through the output regions 76, 78 and capture images one or more images of interior portions of the integrating sphere 70, and in particular one or more images of one or more regions of the optical plate 50 within the integrating sphere 70. The images can be used by the processing subsystem 26, which is electrically associated with the image sensors 22, 24 of the imaging system, to further characterize the physical position/location of the blemishes in the optical plate 50. For example, the processing subsystem 26 may correlate the detector counts with the images captured by the imaging system to determine the location of the blemishes that induced the scattering which caused the detector 21 to increase the detector signal count.

As should be apparent, the number of image sensors and the deployment location of the image sensors is not limited to any particular number or deployment configuration. Practically, any suitable number of image sensors (including a single image sensor) and any suitable deployment configuration can be used, but there may be advantage to using enough image sensors with a particular deployment configuration so that the combined fields of view of the image sensors cover the entirety of the surface area of the major external surfaces 52, 54 of the optical plate 50.

It is noted that although an absorber arrangement 32 is shown in the embodiments illustrated in FIGS. 6 and 7, the integrating sphere embodiments can still be used to advantage without the absorber frame 32.

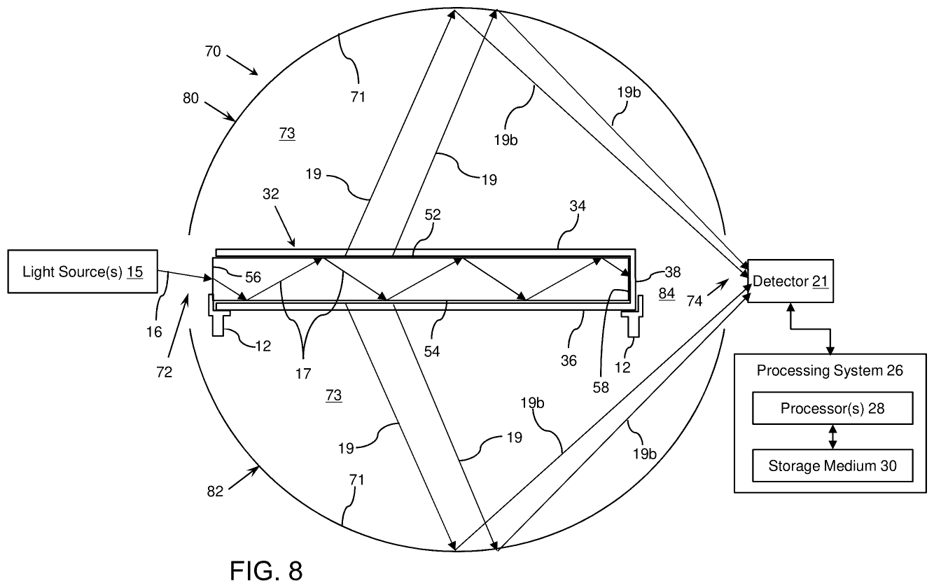

Although the integrating sphere embodiments described thus far have pertained to an integrating sphere implemented as a hollow spherical cavity formed as a single piece, other embodiments are possible in which the integrating sphere is formed from two separate hemi-spherical sections. FIG. 8 illustrates an example of such an embodiment in which the integrating sphere 70 is formed from a pair of hemi-spherical sections 80, 82 that are spatially separated from each other to form an air gap 84 therebetween that is large enough to be able to receive the optical plate 50 therein. In this embodiment, the air gap 84 defines the input region 72 and the output region 74.

The embodiment illustrated in FIG. 8 is of particular value when used in mass-production and testing of optical plates or optical products made from the optical plates. Specifically, the dimension of the air gap 84 allows for rapidly receiving and replacing of optical plates therein, which enables sequential analysis of a large number of optical plates in rapid fashion.

The embodiment of FIG. 8 can be used to further advantage when combined with an imaging system such as that shown in FIG. 7. In particular, if the processing subsystem, using information obtained from the imaging system and the detector arrangement, is able to identify defects in the same location in a group of optical plates, steps can be taken to mitigate the defects in future batch productions. For example, if the optical plates in the group are all from the same batch of prep-processed plates, the pre-processing tools used to produce or pre-process those optical plates can be checked for metrology errors and possibly recalibrated or cleaned (or re-cleaned) in order to prevent similar defects in future batches.

The embodiments described thus far have pertained to detectors that are deployed to detect/sense light that escapes an optical plate through its major external surfaces. However, there may be advantage to employing detectors to detect/sense the propagating light 17 that naturally exits the optical plate 50. In one configuration, which is a variation of the embodiment illustrated in FIGS. 1A-2, the detector 21 can be deployed so as to be associated with the end surface 58 through which the propagating light 17 naturally exits the optical plate 50. In such an embodiment, the detector 21 can be configured to monitor the intensity of the propagating light 17 that naturally exits the optical plate 50 through the end surface 58, and the processing subsystem 26 can derive an integrity measure based on the monitored intensity. For example, the processing subsystem 26 can determine a baseline (i.e., “nominal”) intensity for a “clean plate”, and then compare the monitored intensity for an optical plate under test to the baseline intensity and output a characterization of the optical plate under test based on the comparison. As another example, when the light source 15 is panned and tilted to cover a range of illumination angles, the intensity can be monitored to identify changes (e.g., drops) in the intensity. For example, if the light source 15 is angulated in a first direction such that the beam 16 does not encounter any blemishes, the output intensity monitored by the detector 21 will be maximal, and if the light source 15 is subsequently angulated in a second direction such that the beam 16 encounters a blemish (or blemishes), the output intensity monitored by the detector 21 will be lower than the maximal intensity, and the processing subsystem 26 can characterize the optical plate 50 as a “dirty plate”.

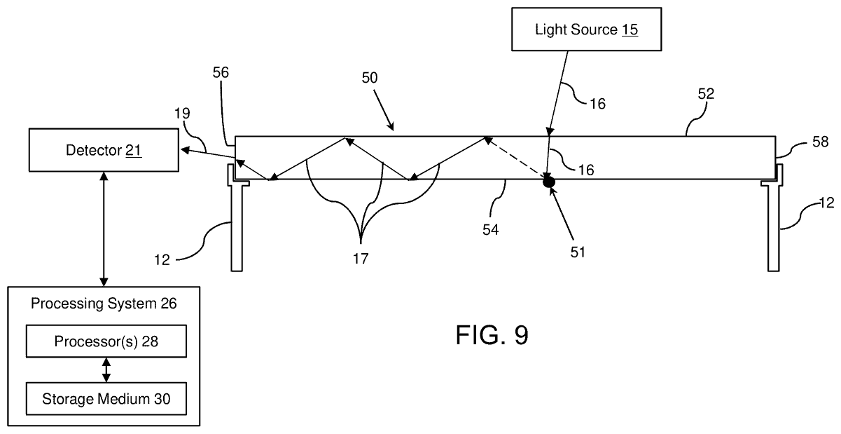

It is noted, however, that monitoring for drops in intensity requires very high precision detection and processing, due largely to the fact that the leakage that induces the intensity drop is typically too small to accurately detect with conventional electronics. Thus, the embodiments described with reference to FIGS. 1A-8 are generally more effective and better-performing than the alternative embodiment mentioned above. A possibly more effective alternative embodiment is schematically illustrated in FIG. 9, which is similar to the embodiment illustrated in FIGS. 1A-2, but in which the locations/positions of the light source 15 and the detector 21 are swapped. Specifically, in the illustrated embodiment the light source 15 is deployed in association with one of the major external surfaces 52 and the detector 21 is deployed in association with one of the end surfaces 56. Here, the light source 15 emits beams of light 16 which impinge on the major external surface 52. If any of the beams 16 encounter a blemish, part of the beam 16 becomes scattered (i.e., undergoes blemish induced scattering) in multiple directions by the blemish and is deflected into the optical plate 50. At least some of the light is deflected at angles which satisfy conditions for internal reflection (one such deflected ray is represented as dashed ray in FIG. 9), and thus at least some of the scattered light is coupled into the optical plate 50 and propagates by internal reflection at the major external surfaces 52, 54 toward the end surface 56. Upon reaching the end surface 56, the propagating light 17 naturally/freely exits the optical plate 50 and is detected/sensed by the detector 21.

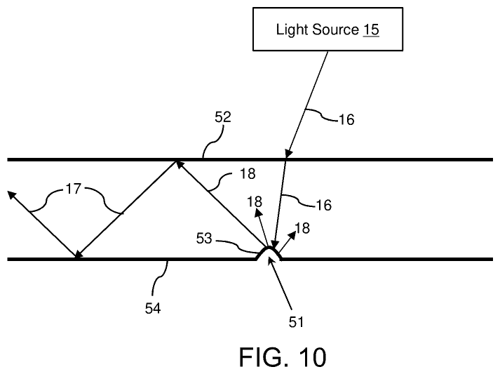

FIG. 10 is a close-up of a section of the optical plate 50 of FIG. 9, illustrating an example of a blemish 51 (having a protrusion 53) in the optical plate 50 that may cause scattering of the light 16 that results in a proportion of the light 16 to be coupled into the optical plate 50 by internal reflection. As illustrated, part of the light 16 that encounters the protrusion 53 is reflected in multiple directions (i.e., scattered) by the protrusion 53, schematically represented by scattered light rays 18. The light rays 18 are scattered in various directions due to the variation in the surface profile of the protrusion 53 such that at least some of the scattered light 18 propagates at angles which satisfy conditions for internal reflection and is coupled into the optical plate 50 (i.e., guided/trapped within the optical plate 50 by internal reflection), so as to propagate by internal reflection at the major external surfaces 52, 54 toward the end surface 56.

It should be clear that the detector 21 can be deployed in association with the other end surface 58 instead of deployment in association with the end surface 56. Alternatively, a pair of detectors can be deployed, each associated with a respective one of the end surfaces 56, 58. It should also be clear that either or both of the major external surfaces 52, 54 may have a light source 15 deployed in association therewith, with one or more detectors 21 correspondingly positioned accordingly.

In the embodiment illustrated in FIGS. 9 and 10, the light source 15 may be configured to emit dispersed light covering a wide angle such that the impinging beams 16 interact with a large region of the major external surface 52. In certain embodiments, a scanning arrangement, such as a scanning mirror, can be deployed adjacent to the light source 15 in order to produce wide beams. The light source 15 may be mounted to a mechanical sliding arrangement, such as a motorized mount, in order to allow lateral movement of the light source 15 along the direction of elongation of the optical plate 50. It is noted, however, that the light 16 from the light source 15 that impinges on the major external surface 52 at certain angles of incidence and does not interact with any blemishes may be coupled into the optical plate 50 and trapped by internal reflection due to the angle of incidence of the impinging light. Therefore, care should be taken to ensure that the light 16 emitted by the light source 15 does not impinge the major external surface 52 at those angles of incidence such that only light that interacts with a blemish will become trapped within the optical plate by internal reflection.

The embodiments described above with reference to FIGS. 9 and 10 may be combined with other embodiments, such as the embodiments described with reference to FIG. 2. For example, an embodiment is contemplated in which a first light source may be deployed in association with the first or second end surface 56 or 58 and a first detector may be deployed in association with the upper or lower major external surface 52 or 54 to sense the light emitted by the first light source that escapes internal reflection due to a blemish or blemishes, and a second light source may be deployed in association with the lower or upper major external surface 54 or 52 to illuminate the optical plate and a second detector may be deployed in association the second or first end surface 58 or 56 to sense the light that is emitted by the second light source and is deflected into the optical plate by a blemish or blemishes so as to be trapped within the optical plate by internal reflection. In such embodiments, the pair of light sources may operate asynchronously, such that the pair of light sources alternate between light emission states (i.e., only one of the two light sources emits illumination at a time). In such a configuration, if a light absorbing frame is used it may be advantageous to employ a moveable member that moves light absorbing surface associated with the major external surface with which the second light source is associated away from that major external surface when the second light source emits light. Alternatively, the pair of light sources may simultaneously emit light.

The optical plates that can be tested using the systems and methods according to the embodiments of the present disclosure can take various forms. In one example, the optical plate is a sample of optical material that has been pre-processed (e.g., cleaned, cut, polished, etc.) in preparation for use as raw material for constructing an optical substrate device, such as a light-guide optical element (LOE) available from Lumus Ltd. of Israel, for use in a near eye display (NED), head mounted display (HMD), or head up display (HUD). In certain embodiments, the pre-processing can include application of one or more layers of optical coating to the major external surfaces of the optical plate, such that the major external surfaces of the optical plate include optical coatings. A non-limiting example of an optical coating is an angularly selective reflective coating, which can provide conditions of internal reflection.

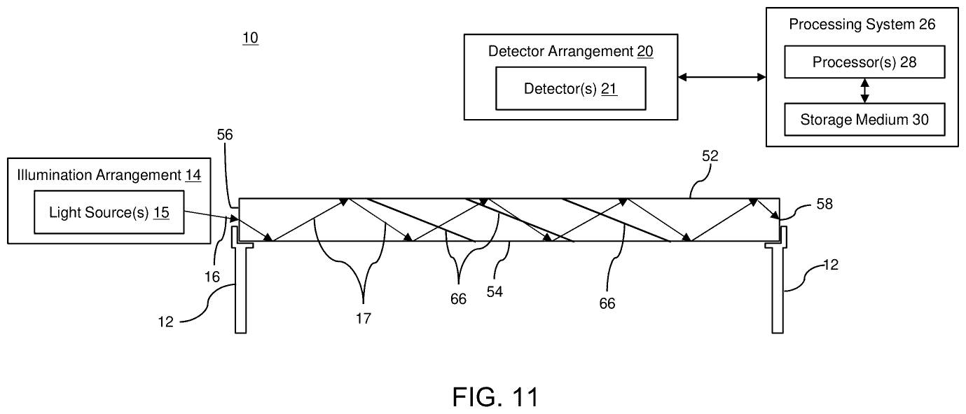

In other embodiments, the optical plate may include one or more embedded optical elements. For example, in certain embodiments the optical plate may include a partially reflective surface or a polarizing element that is embedded within the optical plate parallel to the major external surfaces of the optical plate and extending partially in the direction of elongation of the optical plate. In other embodiments, the optical plate is itself an LOE having embedded therein a series of mutually-parallel partially reflective internal surfaces, inclined obliquely to the major external surfaces of the LOE or inclined obliquely to the direction of elongation of the LOE, that partially traverse the optical plate along the direction of elongation. In such embodiments, the systems and methods according to the embodiments of the present disclosure can be used to identify blemishes, or other defects, in the LOE. FIG. 11 illustrates an example of the system 10 in use for testing an optical plate implemented as an LOE. Here, the LOE includes a series of mutually-parallel partially reflective internal surfaces 66 that traverse the LOE along the direction of elongation, and are obliquely inclined to the major external surfaces 52, 54. It should be apparent that the location of the light source 15 and the orientation of the partially reflective surfaces 66 should inform the decision of where to deploy the detector 21. For example, in the illustrated configuration the injection of the light 16 from the left end surface 56, coupled with the particular orientation of the partially reflective surfaces 66, results in a proportion of the light 17 propagating through the LOE by internal reflection being deflected out of the LOE toward the lower major external surface 54. Thus, in this testing configuration, the detector 21 should be deployed in association with the upper major external surface 52. If the light source 15 were to be positioned proximate the right end surface 58, and the partially reflective surfaces 66 maintained their same orientation, a proportion of the light 17 propagating through the LOE by internal reflection would be deflected out of the LOE toward the upper major external surface 52, and thus the detector 21 would need to be deployed in association with the lower major external surface 54.

In further embodiments, the optical plate under test may be formed as a stack of constituent optical plates, where each plate in the stack may be constructed as optical plate 50. The constituent optical plates may be aligned and bonded together, for example using optical adhesive applied at the major external surfaces of some or all of the constituent optical plates. In such embodiments, the major external surfaces of the constituent optical plates form major internal surfaces of the stack of bonded plates, with the exception of the upper major external surface of the top optical plate in the stack and the lower major external surface of the bottom optical plate in the stack which respectively form the upper and lower major external surface of the stack.

The optical adhesive used to bond together the constituent optical plates may or may not be an index matched adhesive. In cases where the optical adhesive is index matched, the stack of optical plates will behave as a thick optical plate with internally embedded optical coatings in which light may propagate by internal reflection between the major external surfaces of the stack. In cases where the optical adhesive is not index matched, and the refractive index of the optical adhesive is sufficiently lower than the refractive index of the optical plate material to define a critical angle, each optical plate in the stack will behave like an optical plate in air, i.e., for each optical plate, light that is incident to the major external surfaces of the optical plate at angles greater than the critical angle will be trapped between the major external surfaces by total internal reflection. In such cases, a blemish in an optical plate of the stack may cause scattering which results in a loss of conditions of total internal reflection in that optical plate, causing the light to exit that the optical plate and transmit through neighboring optical plates in the stack until completely exiting the stack. In embodiments in which such a stack of optical plates is tested, it may be advantageous to employ an illumination arrangement having a plurality of light sources. For example, the illumination arrangement may include a light source for each of the optical plates of the stack, with each light source providing input illumination to a corresponding one of the optical plates of the stack. Alternatively, a plurality of light sources may be provided with each light source providing input illumination to a different respective group of optical plates of the stack. Practically, the stack can be formed from any number of two or more optical plates, so long as the geometry of the illumination arrangement is adapted accordingly.

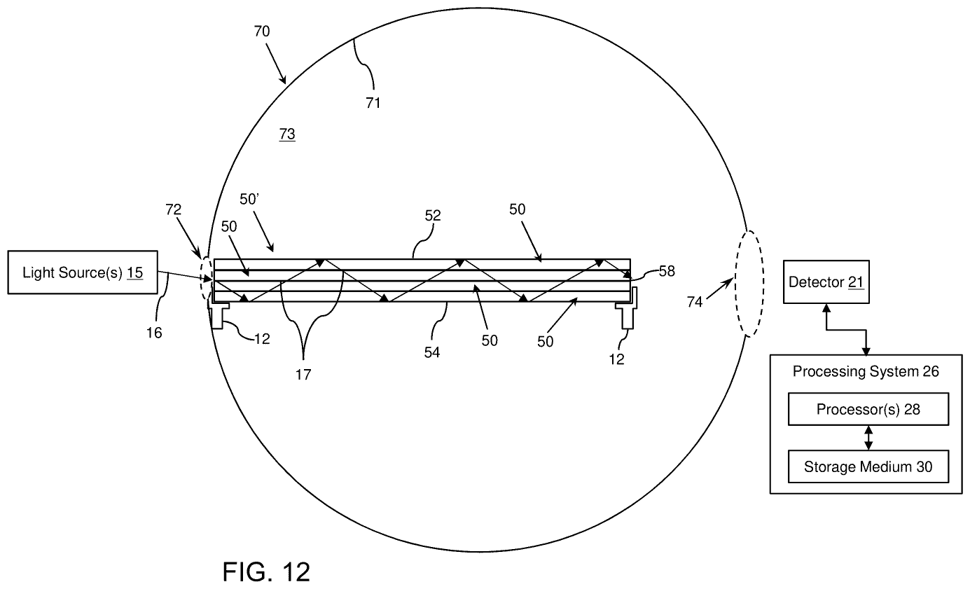

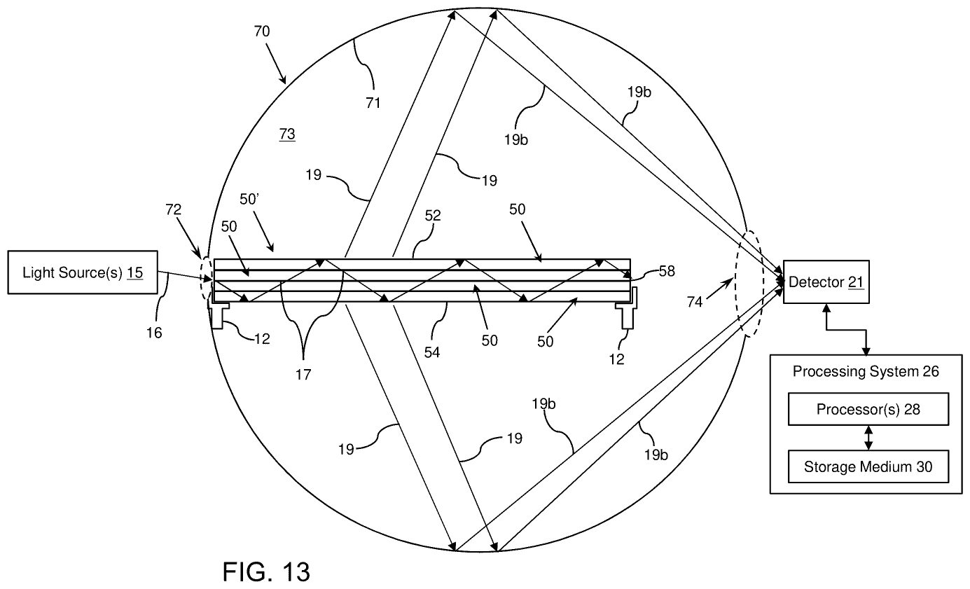

As should be apparent, any of the previously described embodiments can be used to test such a stack of constituent optical plates. By way of one non-limiting illustrative example, FIG. 12 shows an optical plate 50′ formed from a stack of clean constituent optical plates 50 that are bonded together with an index matched optical adhesive, and that is deployed in a test set up similar to the set up illustrated in FIG. 6 (but without the absorbing frame 32). Here, the optical plate 50′ behaves like a thicker version of optical plate 50. Accordingly, light 17 propagates through the optical plate 50′ by internal reflection between the major external surfaces 52, 54 of the optical plate 50′/stack, and none of the internally reflecting light 17 escapes through the major external surfaces 52, 54 (due to lack of blemishes and hence lack of scattering). FIG. 13 illustrates a converse example, in which at least one of the constituent optical plates 50 in the stack has at least one blemish, such that the optical plate 50′ itself has at least one blemish. Here, at least part of the internally reflecting light 17 escapes through one or more of the major external surfaces 52, 54 as light 19.

As mentioned above, the systems and methods of the present disclosure are applicable for testing optical plates of various sizes, and are of particular value when used for testing smaller-scale optical plates that are used in the fabrication of optical substrate devices, or are themselves optical substrate devices, that are used in small form factor near eye display (NED), head mounted display (HMD), or head up display (HUD). Nevertheless, the systems and methods of the present disclosure can be used to test any sample of optical material that is a light-transmitting material having a pair of parallel major external surfaces capable of supporting propagation of light by internal reflection therethrough, including larger-scale optical plates, such as windscreens for automotive use, and sections of plate glass for use as part of windows and/or doors.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form, “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the disclosure.

Although the disclosure has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

1. A system for testing an optical plate for blemishes, the optical plate including a plurality of surfaces including first and second end surfaces and a pair of mutually-parallel major external surfaces for supporting propagation of light through the optical plate by internal reflection at the major external surfaces, the system comprising:
a light source that generates light and is deployed proximate to the optical plate such that the light generated by the light source enters the optical plate proximate the first end surface and propagates through the optical plate toward the second end surface by internal reflection at the major external surfaces; and
a detector arrangement including at least a first detector that is deployed in association with the first of the major external surfaces and configured to detect light generated by the light source that exits the optical plate through the first of the major external surfaces due to blemish induced scattering of the light propagating through the optical plate by internal reflection.

2. The system of claim 1, wherein the detector arrangement further includes a second detector deployed in association with a second of the major external surfaces.

3. The system of claim 1, further comprising: an absorber arrangement including at least one light-absorbing surface, the absorber frame arrangement for deployment relative to the optical plate so that the at least one light-absorbing surface is associated with a corresponding one of the surfaces of the optical plate.

4. The system of claim 3, wherein the plurality of surfaces further includes a first edge surface and a second edge surface, and wherein the at least one light-absorbing surface includes a plurality of light-absorbing surfaces including: a first light-absorbing surface associated with the first of the major external surfaces, a second light-absorbing surface associated with a second of the major external surfaces, a third light-absorbing surface associated with the second end surface, a fourth light-absorbing surface associated with the first edge surface, and a fifth light-absorbing surface associated with the second edge surface.

5. The system of claim 1, wherein the optical plate includes one or more optical coating layers at one or more of the major external surfaces.

6. The system of claim 1, wherein the optical plate includes at least one optical component deployed internal to the optical plate between the major external surfaces.

7. The system of claim 6, wherein the at least one optical component includes a plurality of partially reflecting surface obliquely inclined to the major external surfaces.

8. The system of claim 6, wherein the at least one optical component includes a partially reflecting surface parallel to the major external surfaces.

9. The system of claim 1, wherein the optical plate is formed as a stack of a plurality of constituent optical plates.

10. The system of claim 1, wherein the optical plate is part of a bonded stack of optical plates.

11. The system of claim 1, further comprising: an integrating sphere including an input region associated with the light source and at least a first output region associated with the first detector.

12. The system of claim 11, wherein the first output region is associated with the second end surface of the optical plate.

13. The system of claim 11, wherein the first output region is associated with one of the major external surfaces of the optical plate.

14. The system of claim 1, further comprising: at least one computer processor electrically associated with the detector arrangement and configured to process signals, generated by the detector arrangement in response to the first detector detecting the light generated by the light source that exits the optical plate, to derive an integrity measure of the optical plate.

15. The system of claim 14, wherein the integrity measure is a count of a number of detections of the light generated by the light source that exits the optical plate by the first detector, and wherein the at least one processor is further configured to perform a comparison of the count of the number of detections to one or more thresholds and output a usability status of the optical plate based on the comparison.

16.-40. (canceled)
